(19) United States
(12) Patent Application Publication
(10) Pub. No.: US 2013/0223595 A1
(43) Pub. Date: Aug. 29, 2013

(54) GRATING FOR PHASE CONTRAST IMAGING

(71) Applicant: Gereon Vogtmeier, Aachen (DE)

(72) Inventor: Gereon Vogtmeier, Aachen (DE)

(73) Assignee: KONINKLIJKE PHILIPS ELECTRONICS N.V., EINDHOVEN (NL)

(21) Appl. No.: 13/883,325

(22) PCT Filed: Nov. 3, 2011
(86) PCT No.: PCT/IB11/54890

§ 371 Date: May 3, 2013

(30) Foreign Application Priority Data
Nov. 8, 2010 (EP) 10190351.6

(51) Int. Cl. G21K 1/00; G01N 23/04

(52) U.S. Cl. CPC G21K 1/00; G01N 23/04
USPC 378/62; 378/145; 29/428

(57) ABSTRACT

The present invention relates to foil-gratings for X-ray differential phase-contrast imaging, a detector arrangement and an X-ray imaging system for generating phase-contrast images of an object and a method of producing a foil-grating. In order to provide gratings with a high aspect ratio, a foil-grating (40) for X-ray differential phase-contrast imaging is provided with a first foil (42) of X-ray absorbing material; and at least a second foil (44) of X-ray absorbing material. The at least two foils each comprise a plurality of X-ray absorbing stripes spaced from each other by X-ray transparent apertures, wherein the first foil comprises a first plurality (46) of first stripes (48) with a first width w₁ (50), and a first plurality (52) of first apertures (54) with a first opening width w_{O1} (56) arranged periodically with a first pitch p₁ (58), and wherein the second foil comprises a second plurality (60) of second stripes (62) with a second width w₂ (64), and a second plurality (66) of second apertures (68) with a second opening width w_{O2} (70) arranged periodically with a second pitch p₂ (72). The at least two foils are arranged displaced to each other such that the second stripes are positioned in front of the first apertures such that for the passage of X-ray radiation a plurality (74) of resulting slits (76) is provided with a resulting slit width W_{R} (78) that is smaller than the first w_{O1} and the second opening width w_{O2}. The at least two foils are fixedly attached to each other.

### FIELD OF THE INVENTION

The present invention relates to gratings for X-ray differential phase-contrast imaging, a detector arrangement and an X-ray imaging system for generating phase-contrast images of an object and a method of producing a grating.

### BACKGROUND OF THE INVENTION

Phase-contrast imaging with X-rays is used, for example, to enhance the contrast of low absorbing specimen, compared to conventional amplitude contrast images. This allows to use less radiation applied to the object, for example a patient. In order to be able to use the phase of a wave in relation with phase-contrast imaging, the waves need to have a well-defined phase relation both in time and space. The temporal coherence can be provided by applying monochromatic X-ray radiation. In WO 2004/071298 A1 an apparatus for generating phase-contrast X-ray imaging as described comprises, in an optical path, an incoherent X-ray source, a first beam splitter grating, a second beam recombiner grating, an optical analyzer grating and an image detector. To use higher X-ray energies in differential phase-contrast imaging (DPC), gratings with high aspect ratios are required.

### SUMMARY OF THE INVENTION

Hence, there may be a need to provide gratings with a high aspect ratio.

The object of the present invention is solved by the subject-matter of the independent claims, wherein further embodiments are incorporated in the dependent claims.

It should be noted that the following described aspects of the invention apply also for the foil-grating, the detector arrangement, the X-ray imaging system and the method.

According to an exemplary embodiment of the invention, a foil-grating for X-ray differential phase-contrast imaging is provided comprising a first foil of X-ray absorbing material and at least a second foil of X-ray absorbing material. The at least two foils each comprise a plurality of X-ray absorbing stripes spaced from each other by X-ray transparent apertures. The first foil comprises a first plurality of first stripes with a first width w₁ and a first plurality of first apertures with a first opening width w_{O1} arranged periodically with a first pitch p₁. The second foil comprises a second plurality of second stripes with a second width w₂ and a second plurality of second apertures with a second opening width w_{O2} arranged periodically with a second pitch p₂. The at least two foils are arranged displaced to each other such that the second stripes are positioned in front of the first apertures such that for the passage of X-ray radiation a plurality of resulting slits is provided with a resulting slit width w_{R} that is smaller than the first and the second opening width. The at least two foils are fixedly attached to each other.

In the context of the present invention, the term “foil” relates to a material with a small thickness compared o its extension. The term foil comprises flexible materials, i.e. materials that can be bent in at least one direction, as well as panels or sheets of any other material.

According to a further exemplary embodiment of the invention, the transparent apertures are enclosed by circumferential foil sections connecting the plurality of stripes with each other at their ends, wherein the plurality of stripes and the circumferential foil sections are provided as a continuous foil.

According to a further exemplary embodiment, a detector arrangement of an X-ray system for generating phase-contrast images of an object is provided which comprises a source grating, a phase grating, an analyzer grating and a detector with a sensor. The source grating is adapted to split an X-ray beam of polychromatic spectrum of X-rays. The phase grating is adapted to recombine the splitted beam in an analyzer plane. One of the gratings, e.g. the analyzer grating, is adapted to be stepped transversely over one period of the analyzer grating. The sensor is adapted to record raw image data while being stepped transversely over one period of the analyzer grating. At least one of the gratings is a foil-grating according to the above-mentioned exemplary embodiments.

According to a further exemplary embodiment of the invention, an X-ray imaging system for generating phase-contrast data of an object is provided with an X-ray source generating a beam of polychromatic spectrum of X-rays, an X-ray detector unit providing raw image data of an object, a processing unit for controlling the X-ray source and computing the raw image data generating image data and a display for displaying the computed image data. The X-ray detector unit comprises a detector arrangement according to one of the above-mentioned embodiments.

According to a further aspect of the invention, a method of producing a foil-grating for X-ray differential phase-contrast imaging is provided comprising the following steps: a) providing a first foil of X-ray absorbing material and applying a first plurality of first X-ray transparent apertures with a first opening width w_{O1} arranged periodically with a first pitch p₁ such that a first plurality of X-ray absorbing stripes with a first width w₁ spaced from each other by the first apertures is achieved; b) providing a second foil of X-ray absorbing material and applying a second plurality of second X-ray transparent apertures with a second opening width w_{O2} arranged periodically with a second pitch p₂ such that a second plurality of second stripes with a second width w₂ spaced from each other by the second apertures is achieved; c) positioning the at least two foils displaced to each other such that the second stripes are located in front of the first apertures such that for the passage of X-ray radiation a plurality of resulting slits is provided with a resulting slit width w_{R} that is smaller than the first and the second opening width; and d) attaching the at least two foils are to each other providing a foil-grating.

It can be seen as the gist of the invention to provide foils with apertures produced as small as possible by arranging the at least two foils in a displaced manner such that the resulting slits are provided which have a smaller width than the minimum width that can be provided in the foils themselves. By adapting the remaining stripes when providing the apertures and the foils to be in a certain relation to the opening width, the resulting slit width can be adapted to particular needs.

These and other aspects of the present invention will become apparent from and elucidated with reference to the embodiments described hereinafter.

### BRIEF DESCRIPTION OF THE DRAWINGS

Exemplary embodiments of the invention will be described in the following with reference to the following drawings.

FIG. 1 schematically shows an example of an X-ray system;

FIG. 2 schematically shows detector arrangement of an X-ray system for phase contrast imaging;

FIGS. 3a-c schematically show a first embodiment of a foil-grating according to the invention;

FIG. 4a-b schematically show further embodiments of a foil-grating according to the invention in a cross-section;

FIG. 5 schematically shows the basic method steps of a method for producing a foil-grating according to the invention; and

FIG. 6 schematically shows a further embodiment of a method according to FIG. 5.

### DETAILED DESCRIPTION OF EMBODIMENTS

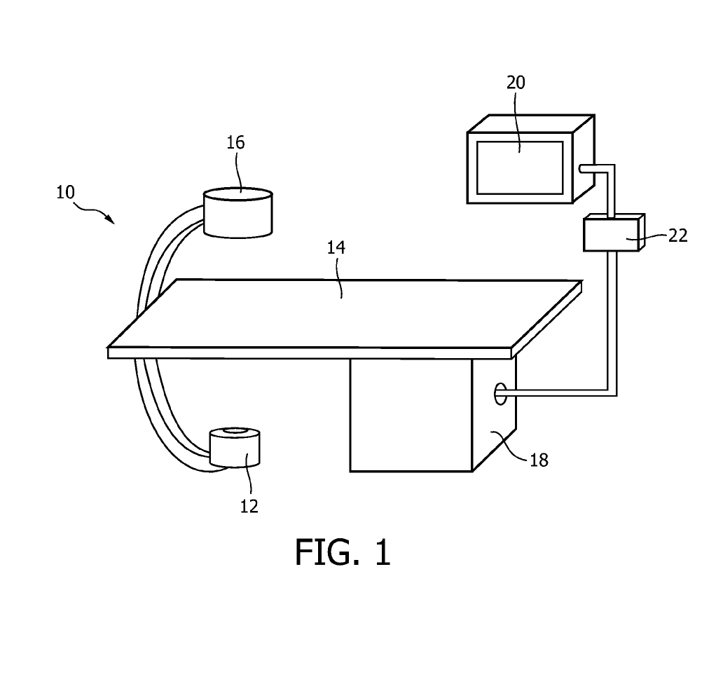

FIG. 1 schematically shows an X-ray imaging system 10 with an examination apparatus for generating phase-contrast images of an object. The examination apparatus comprises an X-ray image acquisition device with a source of X-ray radiation 12 provided to generate X-ray radiation beams with a conventional X-ray source. A table 14 is provided to receive a subject to be examined, for example a patient.

Further an X-ray detector unit 16 according to the invention is basically located opposite the source of X-ray radiation 12 (for detailed explanation see below), i.e. during the radiation procedure the subject is located between the source of X-ray radiation 12 and the detector unit 16. The latter is sending data to a processing unit 18 which is connected to the detector unit 16 and the radiation source 12. The processing unit 18 is located underneath the table 14 to save space within the examination room. Of course, it could also be located at a different place, such as a different room. Further, a display 20 is arranged in the vicinity of the table 14 to display information such as the computed image data to the person operating the X-ray imaging system. Further, an interface unit 22 is arranged to input information by the user. It is noted that the example shown is of a so-called C-type X-ray image acquisition device. The X-ray image acquisition device comprises an arm in form of a C where the image detector is arranged at one end of the C-arm and the source of X-ray radiation 12 is located at the opposite end of the C-arm. The C-arm is movably mounted and can be rotated around the object of interest located on the table 14. In other words, it is possible to acquire images with different directions of view.

It is further noted, that other forms of X-ray image acquisition devices are also possible, such as a gantry with a rotating pair of X-ray source and detector.

According to a preferred embodiment, the subject matter of the invention is used for mammography, where lower energy and not so high intensities as well as a need for high spatial resolution exist. However, the invention is also suitable for C-arm and CT examination.

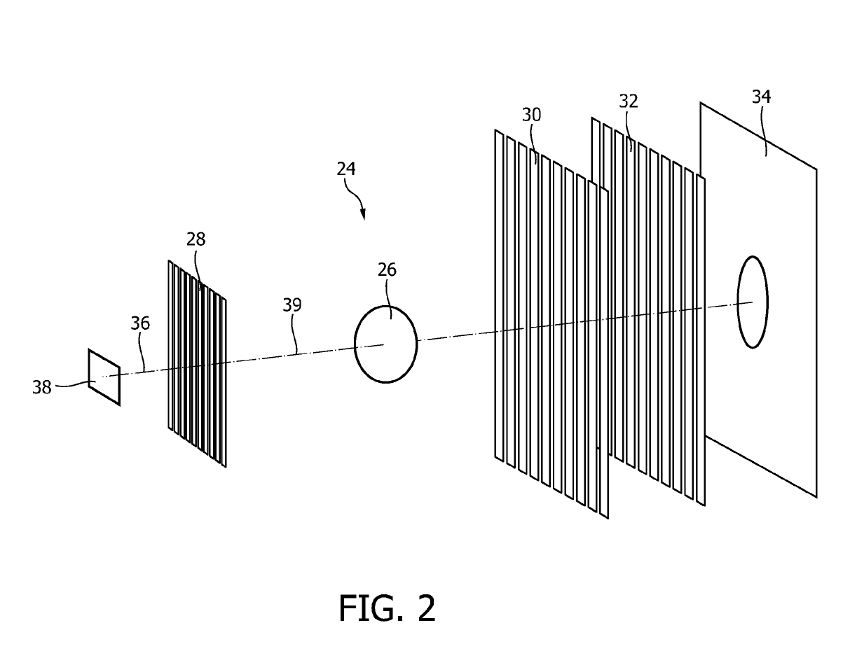

FIG. 2 schematically shows a detector arrangement 24 of an X-ray system for generating phase-contrast images of an object 26. The object 26, for example a patient or a sample as shown in FIG. 2, is arranged between a source grating 28 and a phase grating 30. An analyzer grating 32 is arranged behind the phase grating 30. Further, a detector with a sensor 34 is provided behind the analyzer grating 32.

In case of a C-arm, the source grating is arranged on the opposite side of the C-arm where the source is located. The other gratings are arranged opposite, i.e. on the other side such that the object is arranged between the two ends of the C-arm, and thus between the source grating and the phase grating.

For examination of the object 26, an X-ray beam 36 is of polychromatic spectrum of X-rays is provided by a conventional X-ray source 38. The X-ray radiation beam 36 is applied to the source grating 28 splitting the X-ray radiation such that coherent X-ray radiation is provided. The splitted beam, indicated with reference numeral 39 is applied to the phase grating 30 recombining the split beams in an analyzer plane. After recombining the split beams behind the phase grating 30, the recombined beam is applied to the analyzer grating 36. Finally, the sensor 34 is recording raw image data while one of the gratings, in the example shown the analyzer grating 32, is stepped transversely over one period of the analyzer grating 32. The arrangement of at least one the gratings 28, 30 or 32 comprises an inventive foil grating as described in the following. It is noted that the foil-grating according to the invention is in particular beneficial for the source grating 28.

However, it is noted above it is described that at the beginning, the stepping of the analyzer grating is necessary, but the movement of one of the three gratings is sufficient according to a further aspect and is thus not limited to the analyzer grating.

According to a further aspect, the foil-grating according to the present invention could also be used in a static setup with special measurement methods. Thus, the inventive foil-grating is used for all actual and for all future PCI-setups.

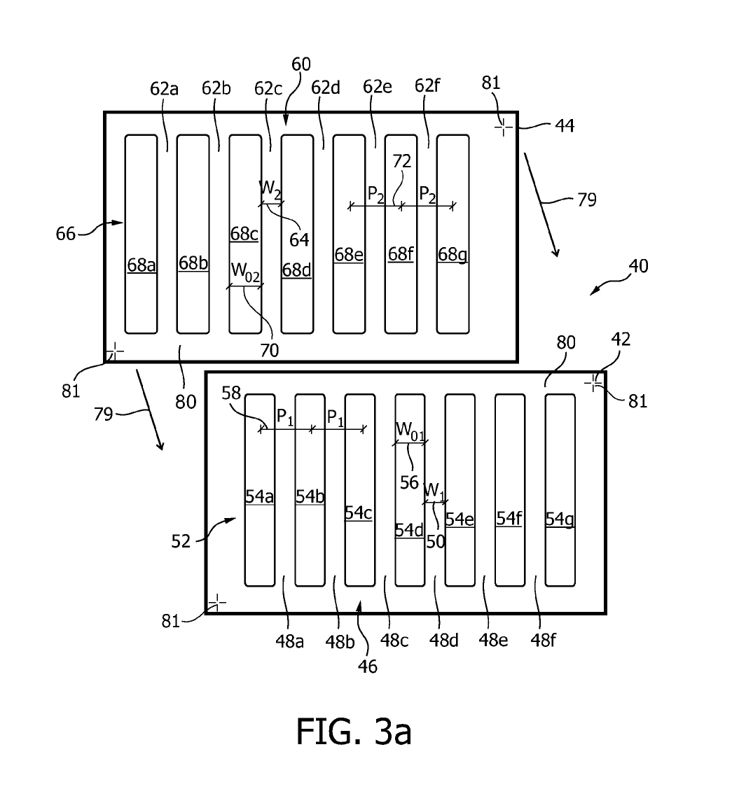

In FIGS. 3a-c, a first embodiment of a foil-grating is shown. FIG. 3a shows a first and a second foil in a so-called exploding perspective drawing before attaching the two foils to each other. FIG. 3b shows a plan view of the two foils attached to each other and FIG. 3c shows a cross-section of the attached foils of FIG. 3b.

FIG. 3a shows a foil-grating 40 for X-ray differential phase-contrast imaging, comprising a first foil 42 of X-ray absorbing material and at least a second foil 44 of X-ray absorbing material. The first foil 42 comprises a first plurality 46 of first stripes 48a,b,c . . . with a first width w₁ 50 and a first plurality 52 of first apertures 54a,b,c . . . with a first opening width w_{O1} 56 arranged periodically with a first pitch p₁ 58. The first stripes are X-ray absorbing since they are made from the foil material. The first apertures 54 are X-ray transparent.

The second foil comprises a second plurality 60 of second stripes 62a,b,c . . . , which are also X-ray absorbing, with a second width w₂ 64 and a second plurality 66 of second apertures 68a,b,c . . . with a second opening w_{O2} 70 arranged periodically with a second pitch p₂ 72. The second apertures 68 are also X-ray transparent.

To provide the foil-grating 40, the at least two foils 42 and 44 are arranged displaced to each other such that the second stripes are positioned in front of the first apertures such that for the passage of X-ray radiation, a plurality 74 of resulting slits 76a,b,c . . . is provided with a resulting slit width w_{R} 78 that is smaller than the first and the second opening width. This combining of the two foils 42, 44 is indicated with two arrows 79. The at least two foils are then fixedly attached to each other, for example by gluing.

The mounted state of the foil-grating 40 is shown in FIG. 3b. For a better understanding, the resulting slits 76 are indicated in a hatched manner.

FIG. 3c show a cross-section of the foil-grating comprising the first and second foils 42, 44.

According to an aspect of the invention, the foils can be metal foils.

According to a further aspect, the transparent apertures are enclosed by circumferential foil sections 80 connecting the plurality of stripes with each other at their ends. This provides an easier handling in the manufacturing process.

According to a preferred exemplary embodiment, as indicated in FIG. 3, the plurality of stripes and the circumferential foil sections are provided as a continuous foil, i.e. as a one-piece foil in which the apertures are arranged.

According to a further aspect, alignment markers 81 are provided outside the area with the resulting slits for improved accuracy during the assembly step.

According to a further aspect, alignment pins and foils with holes are provided as well as the use of additional tools for precise mounting.

According to a further aspect, the first pitch p₁ and the second pitch p₂ are equal.

According to a further aspect, the offset of the displacement is half the pitch p₁, p₂.

In the example shown, the first pitch p₁ and the second pitch p₂ are equal and the offset of the displacement is shown as half the pitch.

According to a further aspect, for each foil, the width of the stripes is smaller than the opening width. Thereby the larger openings can each be divided into two resulting slits.

Of course, it is also possible to provide stripes that have the same width as the opening width, and by a slight lateral displacement, it is possible to cover the opening width partially such that the same number of resulting slits is achieved but with smaller opening width.

According to a further exemplary embodiment (not shown), the second stripes are positioned in front of the first apertures such that each first and second aperture is at least partially covered.

According to a further exemplary embodiment (not shown), the second stripes are positioned in front of the first apertures such that each first and second aperture is at least partially covered.

According to a further exemplary embodiment (not shown), the first and/or second stripes have a nonlinear form, and wherein the first and second apertures have a nonlinear form with different sections with section opening widths w_{SO}; and the displacement of the at least two foils leads to resulting apertures with resulting section opening widths w_{SOR}, which are smaller than the respective section opening widths w_{SO} of the first and second apertures.

For example, the slits can have an L-shaped form and the slits are repeated in a constant pitch in two directions across the foil. By displacement it is possible to achieve resulting slits with an L-cross section with a smaller width in one or two directions.

In the example shown in FIG. 3c, the cross-sections, indicated with reference numeral 82 of the resulting slits are square-like such that the thru-direction, indicated with reference numeral 84, is perpendicular to the foils' direction of extension.

According to a further aspect of the invention, a plurality of first and second foils is provided and stacked in an alternating manner (not further shown). Thus, higher absorption factors can be provided while the same resulting slit sizes are achieved.

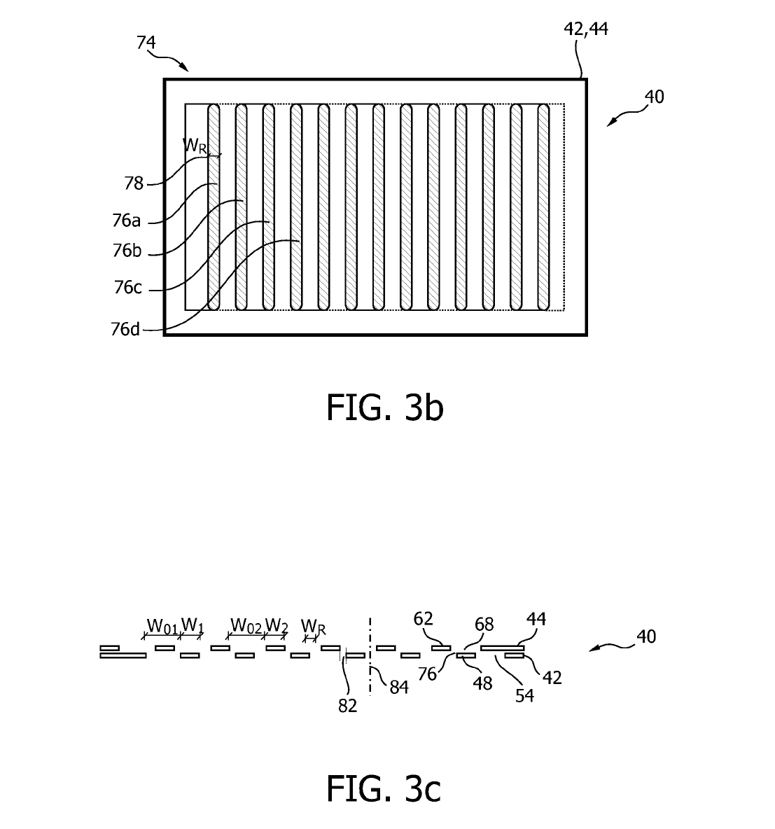

According to a further exemplary embodiment, a plurality number of foils is provided and arranged in a stacked manner with pitches and opening width adapted such that the cross-section, indicated with reference numeral 182 in FIG. 4, of the resulting slits is adapted to different fan beam angles which are indicated by reference numeral 184.

In FIG. 4a, a plurality of foils 142 is shown comprising a number of resulting slits 176 which are provided with an inclined thru-direction, compared with the direction of extension of the foils. In FIG. 4a, all resulting slits 176 have the same angle of inclination, indicated as angle α. In the example shown, the cross-sections of the resulting apertures have a form of a parallelogram. The foils are provided with similar apertures/opening widths and slit widths having the same pitch. They are displaced with a value larger than half the pitch.

In FIG. 4b, a plurality of foils 242 is shown comprising a number of resulting slits 276 which are adapted such to provide thru-openings for the beams in a fan-like manner, which is indicated with dotted centre-lines 284 each having increasing and decreasing angles to the foils' extension.

According to a further aspect, the thru-openings have a trapezoid shape or triangle etc. instead of a rectangular shape.

Thereby the passage direction of the beam can be changed. In the example shown, the cross-sections of the resulting apertures have different forms of a parallelogram. The foils are provided with different opening widths and pitches. The stripes have similar widths.

According to a further aspect, the resulting slits themselves have a trapezoid form, with increasing or decreasing cross-section in radiation direction, thereby allowing to further influence the passing radiation (not shown).

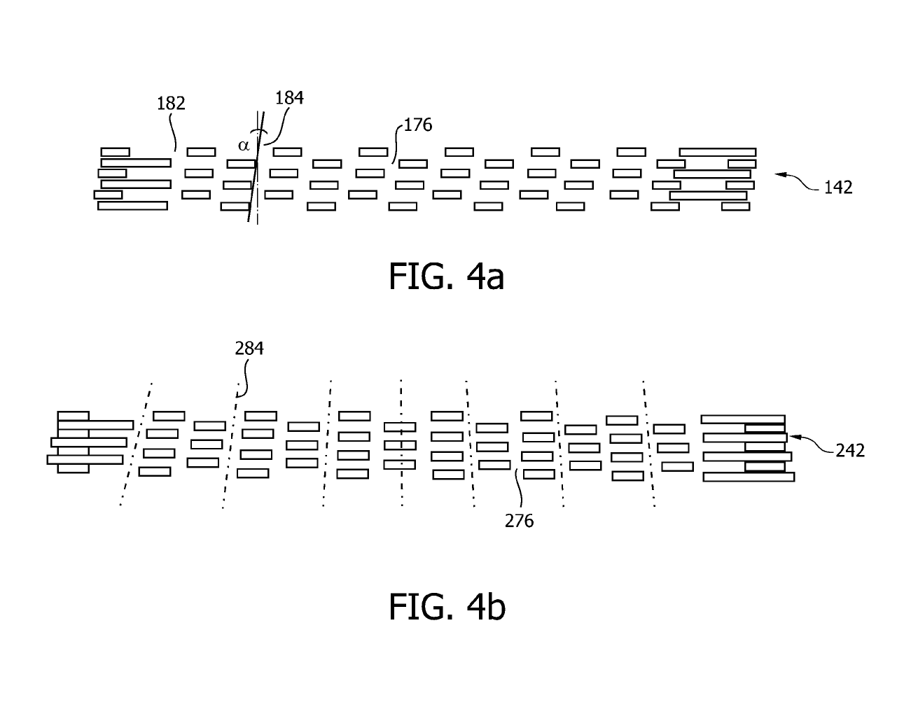

Further, a method 100 of producing a foil-grating for X-ray differential phase-contrast imaging is provided which is shown with its basic steps in FIG. 5, comprising the following steps:

a) In a first providing step 110 a first foil 112 of X-ray absorbing material is provided and in an application step 114 a first plurality of first X-ray transparent apertures 116 with a first opening width w_{O1} is applied, which transparent apertures are arranged periodically with a first pitch p₁ such that a first plurality of first X-ray absorbing stripes with a first width w₁, spaced from each other by the first apertures, is achieved.

b) In a further providing step 120, a second foil 122 of X-ray absorbing material is provided and in a further application step 124, a second plurality of second X-ray transparent apertures 126 is applied which second apertures having a second opening width w_{O2} and which are arranged periodically with a second pitch p₂ such that a second plurality of second stripes with a second width w₂, spaced from each other by the second apertures, is achieved.

c) In a positioning step 130, the at least two foils are positioned displaced to each other such that the second stripes are located in front of the first apertures such that for the passage of X-ray radiation, a plurality of resulting slits 132 is provided with a resulting slit width w_{R} that is smaller than the first and the second opening width.

d) In an attachment step 134, the at least two foils are attached to each other providing a foil-grating 136.

For example, the apertures are applied by laser dicing and/or drilling or metal etching, for example when the foils are metal foils.

For attaching the at least two foils, the foils are glued to each other, as a preferred example.

According to a further aspect, the foils are attached to each other in a non-planar fashion, for example in a curved geometry. Thus, by bending the grating, an alternative to focussed openings is provided.

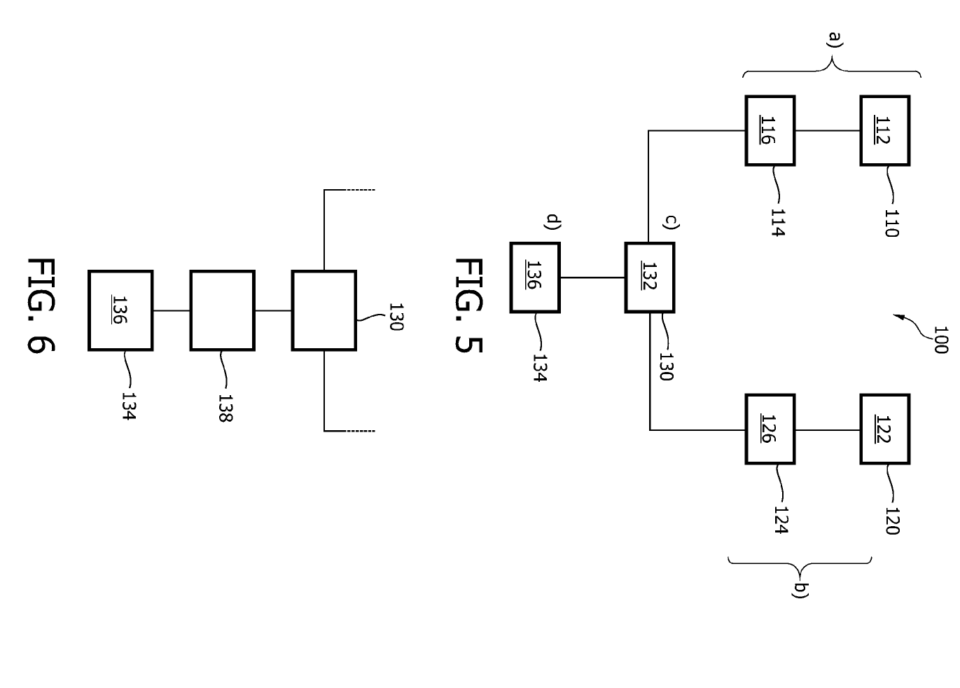

According to a further aspect of the invention, shown in FIG. 6, for the positioning, the foils are aligned with each other in an alignment step 138 with alignment markers which are provided outside the area with the resulting slits.

According to a further aspect of the invention, guiding supports are provided for the alignment during the gluing procedure (not further shown).

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage.

1. A foil-grating (40) for X-ray differential phase-contrast imaging, comprising
a first foil (42) of X-ray absorbing material; and
at least a second foil (44) of X-ray absorbing material;
wherein the at least two foils each comprise a plurality of X-ray absorbing stripes spaced from each other by X-ray transparent apertures;
wherein the first foil comprises a first plurality (46) of first stripes (48) with a first width w₁ (50), and a first plurality (52) of first apertures (54) with a first opening width w_{O1} (56) arranged periodically with a first pitch p₁ (58); and
wherein the second foil comprises a second plurality (60) of second stripes (62) with a second width w₂ (64), and a second plurality (66) of second apertures (68) with a second opening width w_{O2} (70) arranged periodically with a second pitch p₂ (72);
wherein the at least two foils are arranged displaced to each other such that the second stripes are positioned in front of the first apertures such that for the passage of X-ray radiation a plurality (74) of resulting slits (76) is provided with a resulting slit width w_{R} (78) that is smaller than the first w_{O1} and the second opening width w_{O2};
wherein the at least two foils are fixedly attached to each other; and
wherein the second stripes are positioned in front of the first apertures such that each first aperture is divided into two resulting slits by one of the second stripes.

2. Foil-grating according to claim 1, wherein the transparent apertures are enclosed by circumferential foil sections (80) connecting the plurality of stripes with each other at their ends, wherein the plurality of stripes and the circumferential foils sections are provided as a continuous foil.

3. Foil-grating according to claim 1, wherein the first pitch p₁ and the second pitch p₂ are equal; and wherein the offset of the displacement is half the pitch p₁, p₂.

4. Foil-grating according to claim 1, wherein for each foil, the width w₁, w₂ of the stripes is smaller than the opening width w_{O1}, w_{O2}.

5. (canceled)

6. (canceled)

7. (canceled)

8. Foil-grating according to claim 1, wherein the first and/or second stripes have a nonlinear form, and wherein the first and second apertures have a nonlinear form with different sections with section opening widths w_{SO}; and
wherein the displacement of the at least two foils leads to resulting apertures with resulting section opening widths w_{SOR}, which are smaller than the respective section opening widths w_{SO} of the first and second apertures.

9. Foil-grating according to claim 1, wherein a plurality of first and second foils is provided and stacked in an alternating manner.

10. Foil-grating according to claim 1, wherein a plurality number of foils is provided and arranged in a stacked manner with pitches and opening widths adapted such that the cross-section (82) of the resulting slits is adapted to different fan-beam angles (84).

11. A detector arrangement (24) of an X-ray system for generating phase-contrast images of an object (26), with
a source grating (28);
a phase grating (30);
an analyzer grating (32); and
a detector with a sensor (34);
wherein the source grating is adapted to split an X-ray beam of polychromatic spectrum of X-rays (36); wherein the phase grating is adapted to recombine the splitted beam in an analyser plane; wherein one of the gratings is adapted to be stepped transversely over one period of the analyzer grating;
wherein the sensor is adapted to record raw image data while being stepped transversely over one period of the analyzer grating;
wherein at least one of the gratings is a foil-grating according to claim 1.

12. Detector arrangement according to claim 1.

13. An X-ray imaging system (10) for generating phase-contrast data of an object, with
an X-ray source (12) generating a beam of polychromatic spectrum of X-rays;
an X-ray detector unit (16) providing raw image data of an object;
a processing unit (18) for controlling the X-ray source and computing the raw image data generating image data; and
a display (20) for displaying the computed image data;
wherein the X-ray detector unit comprises a detector arrangement according to claim 11.

14. A method (100) of producing a foil-grating for X-ray differential phase-contrast imaging comprising the following steps:
a) providing (110) a first foil (112) of X-ray absorbing material and applying (114) a first plurality of first X-ray transparent apertures (116) with a first opening width w_{O1} arranged periodically with a first pitch p₁ such that a first plurality of first X-ray absorbing stripes with a first width w₁ spaced from each other by the first apertures is achieved; and
b) providing (120) a second foil (122) of X-ray absorbing material and applying (124) a second plurality of second X-ray transparent apertures (126) with a second opening width w_{O2} arranged periodically with a second pitch p₂ such that a second plurality of second stripes with a second width w₂ spaced from each other by the second apertures is achieved;
c) positioning (130) the at least two foils displaced to each other such that the second stripes are located in front of the first apertures such that for the passage of X-ray radiation a plurality of resulting slits (132) is provided with a resulting slit width w_{R} that is smaller than the first w_{O1} and the second opening width w_{O2}; wherein the second stripes are positioned in front of the first apertures such that each first aperture is divided into two resulting slits by one of the second stripes; and
d) attaching (134) the at least two foils to each other providing a foil-grating (136).

15. Method according to claim, wherein for the positioning, the foils are aligned with each other with alignment markers (138) which are provided outside the area with the resulting slits.
